(19) United States
(12) Patent Application Publication
(10) Pub. No.: US 2026/0044706 A1
(43) Pub. Date: Feb. 12, 2026

(54) COMPUTATIONAL STORAGE SYSTEM, OPERATING METHOD THEREOF, AND ELECTRONIC DEVICE

(71) Applicant: SAMSUNG ELECTRONICS CO., LTD., Suwon-si (KR)

(72) Inventor: Sooyoung Ji, Suwon-si (KR)

(73) Assignee: SAMSUNG ELECTRONICS CO., LTD., Suwon-si (KR)

(21) Appl. No.: 19/269,894

(22) Filed: Jul. 15, 2025

(30) Foreign Application Priority Data
Aug. 7, 2024 (KR) 10-2024-0105361

(51) Int. Cl. G06N 3/04

(52) U.S. Cl. CPC G06N 3/04

(57) ABSTRACT

Provided is a computational storage system including a storage device including a model storage configured to store a plurality of neural network models, and a computing device configured to generate inferred image data corresponding to original image data, based on the plurality of neural network models. The computing device is further configured to, in a process of generating the inferred image data, based on a number of a time a target neural network model from among the plurality of neural network models is used increasing by a first threshold value or more, generate at least one first sub-neural network model by dividing the target neural network model and stores the at least one first sub-neural network model in the model storage.

### CROSS-REFERENCE TO RELATED APPLICATION(S)

This application is based on and claims priority under 35 U.S.C. § 119 to Korean Patent Application No. 10-2024-0105361, filed on Aug. 7, 2024, in the Korean Intellectual Property Office, the disclosure of which is herein incorporated by reference in its entirety.

### BACKGROUND

One or more example embodiments of the disclosure relate to a computational storage system, an operating thereof, and an electronic device for maximizing storage space utilization and ensuring security of data storage in a storage device by managing a neural network model in a segmented manner.

In an electronic device including a storage device and a host device, commands (or programs) and data are stored in the storage device, and, to perform data processing based on commands, the commands and the data need to be transmitted from the storage device to the host device. Therefore, even when a processing speed of the host device increases, a data transfer speed between the host device and the storage device may become an obstacle to performance improvement and limit a processing capacity of an entire system. To solve the problems, computational storage systems that include both components of related art storage devices and computing devices capable of processing data are being researched. As a result of data processing in a computing device due to a request from a host device, a variety of multimedia data may be generated. In a case of multimedia data, since the multimedia data is generally large-capacity data, the large-capacity data needs a large data storage space when stored in a storage device. At this time, when the storage space where multimedia data is stored in the storage device is not managed efficiently, a performance of an entire electronic device including the computational storage system may be deteriorated due to an insufficient storage space. Also, data (e.g., multimedia data) stored in storage devices may be lost due to external accidents or instability of internal systems. Therefore, to solve the problem, it is necessary to develop a method to efficiently manage a storage space of a storage device when storing multimedia data while safely managing stored data.

### SUMMARY

One or more example embodiments of the disclosure provide a computational storage system for efficiently managing a storage space in a storage device based on a neural network model and safely managing data stored in the storage device based on a neural network model, an operating method thereof, and an electronic device.

The technical goals of the disclosure are not limited to the technical goals mentioned above, and other technical goals not mentioned will be clearly understood by one or ordinary skill in the art from descriptions below.

According to an aspect of an example embodiment of the disclosure, there is provided a computational storage system including a storage device including a model storage configured to store a plurality of neural network models, and a computing device configured to generate inferred image data corresponding to original image data, based on the plurality of neural network models, wherein the computing device is further configured to, in a process of generating the inferred image data, based on a number of times a target neural network model from among the plurality of neural network models is used increasing by a first threshold value or more, generate at least one first sub-neural network model by dividing the target neural network model and store the at least one first sub-neural network model in the model storage.

According to an aspect of an example embodiment of the disclosure, there is provided a computational storage system including a storage device including a model storage, the model storage being configured to store a plurality of neural network models, at least one sub-neural network model generated by dividing at least one of the plurality of neural network models, and model lists respectively corresponding to the at least one sub-neural network model, wherein the computing device is further configured to, based on at least one of the plurality of neural network models and the at least one sub-neural network model being lost: based on a model list of the lost at least one neural or sub-neural network model, select at least one recovery neural network model from among the plurality of neural network models and the at least one sub-neural network model; and recover the lost at least one neural or sub-neural network model by using the at least one recovery neural network model.

According to an aspect of an example embodiment of the disclosure, there is provided an electronic device including at least one memory configured to store a plurality of neural network models, and at least one processor configured to generate inferred image data corresponding to original image data, based on base data and an event table generated from the original data, by using the plurality of neural network models, and based on a number of times a target neural network model from among the plurality of neural network models is used increasing by a threshold value or more during a process of generating the inferred image data, divide the target neural network model to generate at least one sub-neural network model.

### BRIEF DESCRIPTION OF DRAWINGS

Example embodiments of the disclosure will be more clearly understood from the following detailed description taken in conjunction with the accompanying diagrams in which:

FIG. 1 is a block diagram of an electronic device according to one or more embodiments;

FIG. 2 is a block diagram showing a computational storage system according to one or more embodiments;

FIG. 3 is a diagram illustrating an operation of a computational storage system, according to one or more embodiments;

FIG. 4A is a diagram illustrating an operation of a computational storage system, according to one or more embodiments;

FIG. 4B is a diagram illustrating an example of an event table of a computational storage system. according to one or more embodiments;

FIGS. 5A to 5D are diagrams illustrating an operation of a computational storage system, according to one or more embodiments;

FIGS. 6A and 6B are diagrams illustrating an operation of a computational storage system, according to one or more embodiments;

FIGS. 7A to 7C are diagrams illustrating an operation of a computational storage system, according to one or more embodiments;

FIG. 8 is a diagram illustrating an example of a structure of a neural network model and a sub-neural network model, according to one or more embodiments; and

FIG. 9 is a block diagram illustrating an electronic device according to one or more other embodiments.

### DETAILED DESCRIPTION

In this specification, generating a neural network model based on base data and an event table may mean training a neural network model based on the base data and the event table.

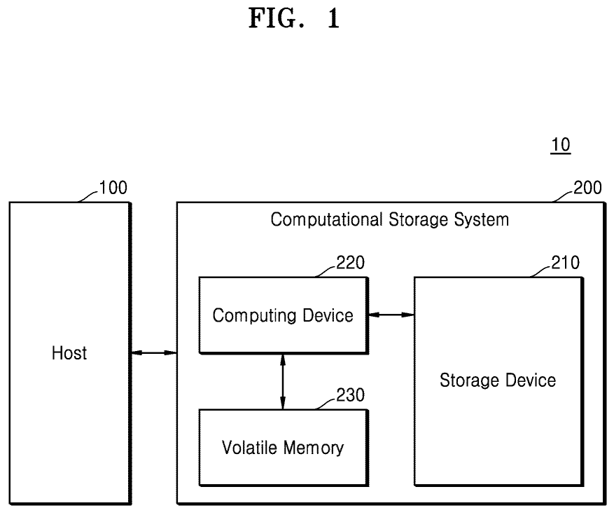

In this specification, in response to reception of a request from a host device (e.g., 100 in FIG. 1) or input (or generation) of original image data to a computational storage system (e.g., 200 in FIG. 1), the computational storage system 200 may generate inferred image data (corresponding to the original image data) based on base data and an event table by using at least one neural network model.

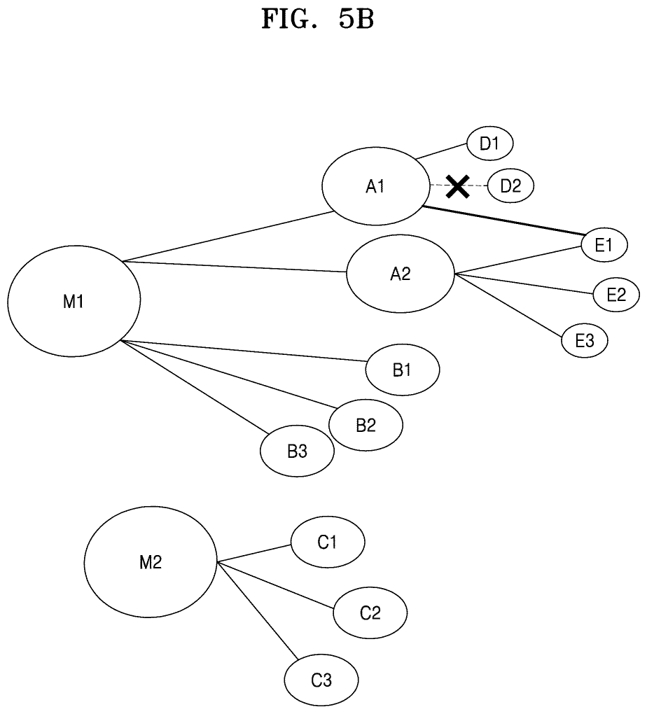

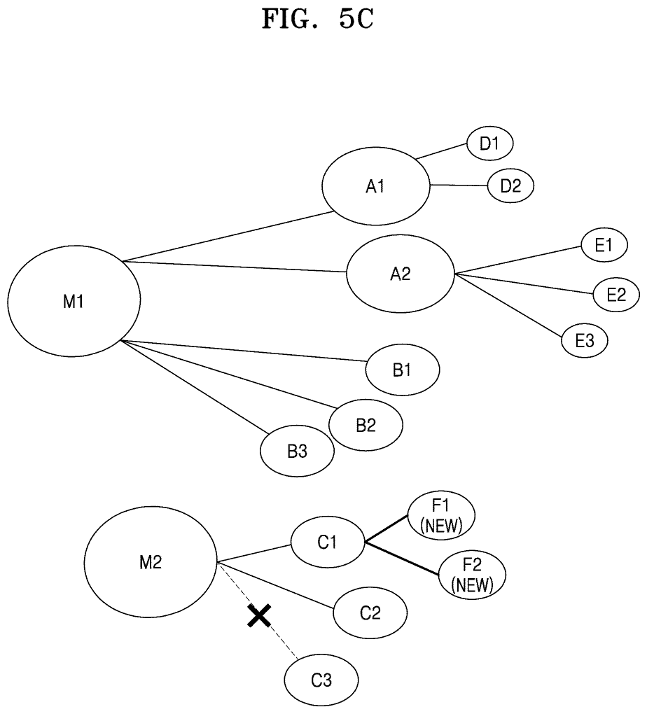

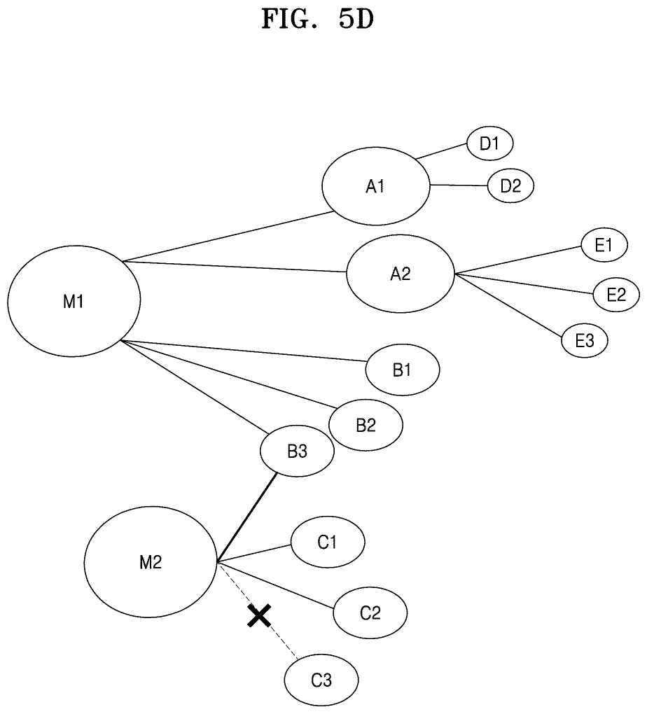

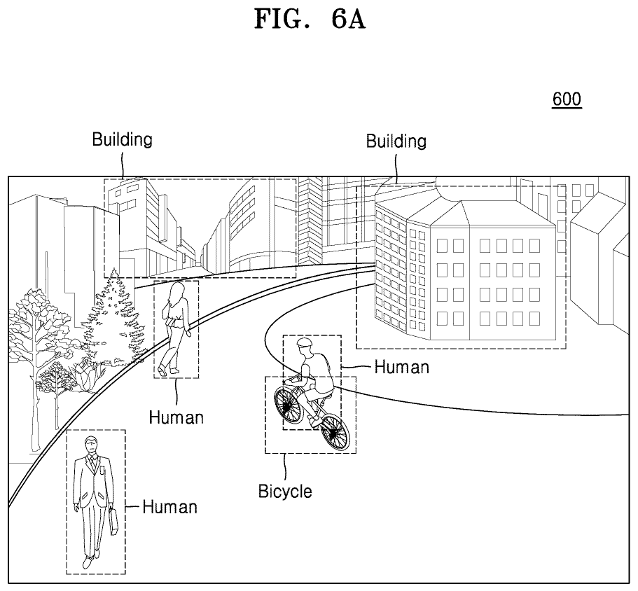

In this specification, a first sub-neural network model may refer to a sub-neural network model generated by dividing a neural network model (e.g., M1 and M2 of FIG. 5A), a second sub-neural network model may refer to a sub-neural network model generated by dividing the first sub-neural network model, and a third sub-neural network model may refer to a sub-neural network model generated by dividing the second sub-neural network model.

FIG. 1 is a block diagram of an electronic device according to one or more embodiments.

Referring to FIG. 1, an electronic device 10 according to one or more embodiments may include the host device 100 and the computational storage system 200.

The electronic device 10 may be, for example but not limited to, a personal computer (PC), a data server, an ultra mobile PC (UMPC), a workstation, a netbook, a network-attached storage (NAS), a smart television, an Internet of Things (IoT) device, a portable electronic device, etc. The portable electronic device may be a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book device, a wearable device, etc.

The host device 100 may control overall operations of the electronic device 10. The host device 100 may store data in the computational storage system 200 and read data from the computational storage system 200. For example, the host device 100 may store a write request and write data in the computational storage system 200 and/or transmit a read request to the computational storage system 200. Also, the host device 100 may assign a task and data to the computational storage system 200 and control the computational storage system 200 to perform the task. For example, the host device 100 may transmit a data processing request for performing a task together with data to be processed by the computational storage system 200 to the computational storage system 200 and/or may transmit a data processing request for data already stored in the computational storage system 200 to the computational storage system 200.

According to one or more embodiments, the host device 100 may transmit an inferred image generation request to the computational storage system 200. The inferred image generation request may be a request for a computing device 220 included in the computational storage system 200 to generate inferred image data corresponding to original image data and store the inferred image data in a storage device 210 included in the computational storage system 200. The inferred image generation request may be transmitted from the host device 100 to the computational storage system 200 based on a user's selection or request for the corresponding function.

According to one or more embodiments, the host device 100 may transmit a neural network model division request to the computational storage system 200.

According to one or more embodiments, the host device 100 may transmit a data (e.g., a neural network model) recovery request to the computational storage system 200.

The host device 100 may be implemented as, for example but not limited to, a central processing unit (CPU), a processor, a micro-processor, an application processor (AP), or a system-on-a-chip (SoC).

The computational storage system 200 may include the storage device 210, the computing device 220, and a volatile memory (VM) 230. The computational storage system 200 may be referred to as a computational storage device. The computational storage system 200 may store data or process data in response to a request from the host device 100. According to one or more embodiments, the computational storage system 200 may be implemented as a storage acceleration platform that accelerates data processing by internally storing and processing data. For example, the computational storage system 200 may be a smart solid state drive (SSD).

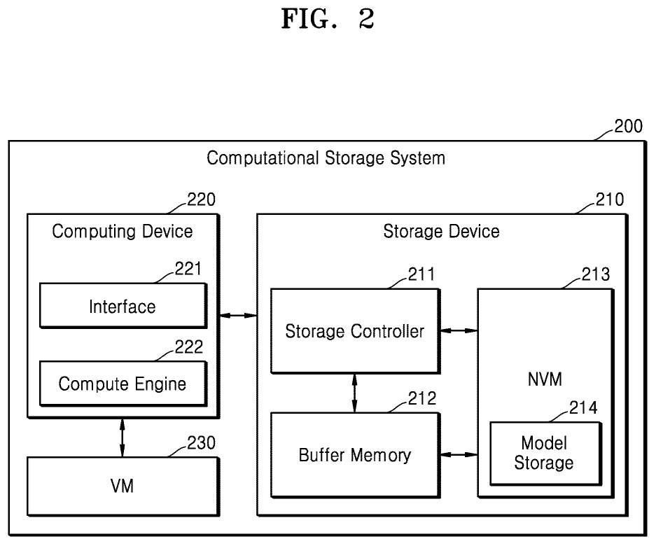

The storage device 210 may store data provided from the host device 100. According to one or more embodiments, the storage device 210 may store base data, an event table, and a neural network model generated by the computing device 220. Also, according to one or more embodiments, the storage device 210 may store original image data (or at least a portion of the original image data) and/or inferred image data (or at least a portion of the inferred image data) generated by the computing device 220. The configuration and the operation of the storage device 210 will be described in more detail later with reference to FIG. 2.

The computing device 220 may be a device that performs data processing on received data and may perform data processing in response to a data processing request received from the host device 100. For example, the computing device 220 may perform data processing on input data by executing an application. The application may include multiple data operations related to performing a task, such as an arithmetic operation, a convolution operation, and a polling operation. For example, when the computing device 220 performs a neural network-based task, the application may include a neural network model. A neural network model may include a plurality of data operations based on, for example but not limited to, at least one from among a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep relief network (DBN), a restricted boron machine (RBM), a fully convolutional network, a long short-term memory (LSTM) network, a classification network, and various other types of neural networks and input, and output sizes, weights, and biases of the plurality of data operations. For example, the neural network model may be a generative model and may be a deep-fake model.

For example, the computing device 220 may be implemented with a graphic processing unit (GPU), a digital signal processor (DSP), an field programmable gate array (FPGA), an application specific integrated circuit (ASIC), a neural processing unit (NPU), etc. However, the disclosure is not limited thereto, and the computing device 220 may be implemented with various types of acceleration circuits (or accelerators) that perform data processing, such as data operations, demanded to perform assigned tasks in parallel.

According to one or more embodiments, the computing device 220 may generate inferred image data corresponding to original image data, based on base data and an event table by using a neural network model, in response to the inferred image generation request received from the host device 100 (or input of original image data to the computational storage system 100). For example, the computing device 220 may generate at least one region-specific inferred image data corresponding to each neural network model by using at least one region-specific neural network model (here, at least one region means a region included in original image data (e.g., a person region, a background region, etc. in the original image data, which may be, for example, closed circuit television (CCTV) footage)). For example, the computing device 220 may generate at least one piece of section-specific inferred image data corresponding to each neural network model by using at least one section-specific neural network model (here, at least one section means a section included in original image data (e.g., a straight driving section, a corner driving section, an intersection driving section, etc. in in the original image data, which may be a dashboard camcorder footage)).

According to one or more embodiments, the computing device 220 may divide a neural network model in response to the neural network model division request from the host device 100 (or an input of original image data to the computational storage system 100) to generate at least one sub-neural network model.

According to one or more embodiments, the computing device 220 may recover lost data (e.g., a neural network model) in response to the data recovery request from the host device 100 (or data loss in the storage device 210). The configuration and the operation of the computing device 220 will be described in more detail later with reference to FIG. 2.

The VM 230 may store data used for data processing of the computing device 220. The VM 230 may store data generated by the computing device 220 or data generated as a result of data processing. At this time, when the computing device 220 performs data processing based on data stored in the storage device 210, the data stored in the storage device 210 (e.g., base data, an event table, a neural network model, at least one sub-neural network model generated by dividing a neural network model, etc.) may be read out and stored in the VM 230.

The VM 230 may be implemented with a VM such as dynamic random access memory (DRAM), static RAM (SRAM), etc.

FIG. 2 is a block diagram showing a computational storage system according to one or more embodiments.

Referring to FIG. 2, the computational storage system 200 according to one or more embodiments may include the storage device 210, the computing device 220, and the VM 230.

The computing device 220 may include an interface 221 and a compute engine 222.

The interface 221 may manage transmission of requests, data, etc. between the host device 100 and the compute engine 222 within the computing device 220, in the computational storage system 200. Also, the interface 221 may manage transmission of requests, data, etc. between the host device 100 and the storage device 210 in the computational storage system 200.

The interface 221 may receive a data processing request and the inferred image generation request from the host device 100. The data processing request may be a request for the computing device 220 to perform data processing on data already stored in the storage device 210 or data processing on data received from the host device 100. When the interface 221 receives the data processing request from the host device 100, the interface 221 may transmit the data processing request to the compute engine 222. Therefore, data processing corresponding to the data processing request may be performed through the compute engine 222 of the computing device 220.

According to one or more embodiments, the interface 221 may receive the inferred image generation request from the host device 100. The inferred image generation request may be a request for the computing device 220 to generate inferred image data corresponding to original image data by using a neural network model and store the inferred image data in the storage device 210. When the interface 221 receives the inferred image generation request from the host device 100, the interface 221 may transmit the inferred image generation request to the compute engine 222. Therefore, inferred image data may be generated based on base data and an event table through the compute engine 222 of the computing device 220.

According to one or more embodiments, (even when the inferred image generation request is not received from the host device 100), the computational storage system 200 may generate the inferred image data based on the base data and the event table through the compute engine 222 when original image data is input to the computational storage system 200 (or original image data is generated). In other words, the compute engine 222 of the computing device 220 may generate inferred image data by using a neural network model for each region (or each section) in response to input of original image data to the computational storage system 200 (or generation of the original image data).

According to one or more embodiments, the compute engine 222 of the computing device 220 may adjust a generation speed of inferred image data according to a performance of the compute engine 222. For example, the compute engine 222 may slowly generate inferred image data through a background process depending on the performance of the compute engine 222. In another example, the compute engine 222 may quickly generate inferred image data in real time in response to reception of the inferred image generation request from the host device 100 (or input of original image data), depending on the performance of the compute engine 222.

According to one or more embodiments, the interface 221 may receive the neural network model division request from the host device 100. The neural network model division request may be a request for the computing device 220 to divide a neural network model to generate at least one sub-neural network model and store the at least one sub-neural network model in the storage device 210 (e.g., a model storage 214). When the interface 221 receives the neural network model division request from the host device 100, the interface 221 may transmit the neural network model division request to the compute engine 222. Therefore, at least one sub-neural network model may be generated through the compute engine 222 of the computing device 220.

According to one or more embodiments, (even when the neural network model division request is not received from the host device 100), the computational storage system 200 may generate at least one sub-neural network model by dividing a neural network model through the compute engine 222 when original image data is input to the computational storage system 200 (or original image data is generated).

According to one or more embodiments, the interface 221 may receive the data (e.g., a neural network model) recovery request from the host device 100. The data recovery request may be a request to recover lost data when data (e.g., a neural network model) in the storage device 210 (e.g., the model storage 214) is lost due to an unexpected event or accident. When the interface 221 receives the data recovery request from the host device 100, the interface 221 may transmit the data recovery request to the compute engine 222. Therefore, data (e.g., a neural network model) in the storage device 210 may be recovered by using remaining neural network models (or remaining sub-neural network models) and/or a model list corresponding to respective sub-neural network models through the compute engine 222 of the computing device 220.

According to one or more embodiments, (even when the data recovery request is not received from the host device 100), the computational storage system 200 may recover data (e.g., a neural network model) by using the remaining neural network models (or the remaining sub-neural network models) via the compute engine 222 when data loss occurs in the storage device 210.

According to one or more embodiments, the interface 221 may receive a neural network model read request from the host device 100. The neural network model read request may be a request to read a neural network model stored in the storage device 210. When the interface 221 receives the neural network model read request from the host device 100, the interface 221 may transmit the neural network model read request to the storage device 210. Therefore, the neural network model may be read from a non-volatile memory (NVM) 213 of the storage device 210 and transmitted to the host device 100.

The compute engine 222 may perform data processing in response to a data processing request. The compute engine 222 may perform data processing on data already stored in the storage device 210 or data processing on data received from the host device 100 in response to the data processing request. The compute engine 222 may store values computed during data processing in internal registers. Also, the compute engine 222 may store data generated during the data processing process and data generated as a result of processing data in the VM 230. The compute engine 222 may store data generated as a result of data processing in the storage device 210 through the interface 221.

According to one or more embodiments, the compute engine 222 may generate a neural network model that generates inferred image data (corresponding to original image data), based on base data and an event table. For example, the compute engine 222 may generate at least one neural network model corresponding to each of at least one region included in the original image data. In another example, the compute engine 222 may generate at least one neural network model corresponding to each of at least one section included in the original image data.

According to one or more embodiments, the compute engine 222 may generate inferred image data based on base data and an event table by using a neural network model, in response to the inferred image generation request. Here, the base data may mean basic raw data of at least one object included in the original image data, and the event table may mean data generated by mapping respective events occurring in the base data and times at which the respective events occurred.

The inferred image data may be image data generated by the compute engine 222 (or a neural network model) based on region-specific or section-specific features of the original image data (e.g., region-specific or section-specific base data and event(s) of the original image data). In other words, the compute engine 222 may generate the inferred image data by using a neural network model in response to the inferred image generation request, and, when a matching rate between the original image data and the inferred image data is greater than or equal to a pre-set threshold value (e.g., 80%), the compute engine 222 may store base data, an event table, and a neural network model instead of storing the original image data.

According to one or more embodiments, the compute engine 222 may divide the original image data into at least one region (or at least one section) based on whether the data size of the event table in the original image data increases beyond a pre-set size.

According to one or more embodiments, the compute engine 222 may generate at least one region-specific inferred image data corresponding to each neural network model by using at least one region-specific neural network model.

According to one or more embodiments, the compute engine 222 may generate at least one piece of section-specific inferred image data corresponding to each neural network model by using at least one section-specific neural network model.

According to one or more embodiments, after generating the inferred image data, when the matching rate between original image data and the inferred image data is greater than or equal to the pre-set threshold value (e.g., 80%), the compute engine 222 may generate a storage request for storing the base data, the event table, and the neural network model based on which the inferred image data is generated by using an access protocol shared by a storage controller 211 (at this time, the original image data may be deleted).

According to one or more embodiments, after generating the inferred image data, when the matching rate between original image data and the inferred image data is less than the pre-set threshold value (e.g., 80%) (and when an increasing rate of the matching rate also increases less than a threshold value (e.g., 2%)), the compute engine 222 may generate a storage request for storing the original image data by using the access protocol shared by the storage controller 211 (at this time, the base data, the event table, and the neural network model may be deleted).

According to one or more embodiments, after generating the inferred image data, when the matching rate between original image data and the inferred image data is less than the pre-set threshold value (e.g., 80%), the compute engine 222 may re-generate the neural network model based on the base data and the event table. The compute engine 222 may re-generate inferred image data by using a re-generated neural network model. When the matching rate between original image data and re-generated inferred image data is greater than or equal to the pre-set threshold value (e.g., 80%), a storage request for storing the base data, the event table, and the neural network model based on which the inferred image data is generated may be generated by using the access protocol shared by the storage controller 211.

The storage request for storing the base data, the event table, and the neural network model generated by the compute engine 222 or the storage request for storing the original image data may be transmitted to the storage device 210 through the interface 221.

According to one or more embodiments, during the process of generating the inferred image data, when a number of times a target neural network model from among a plurality of neural network models is used increases by a first threshold value or more, the compute engine 222 may divide the target neural network model to generate at least one first sub-neural network model and store the first sub-neural network model in the model storage 214. The compute engine 222 may generate at least a portion of first target inferred image data based on the at least one first sub-neural network model. Here, the first target inferred image data may mean inferred image data generated by the target neural network model.

According to one or more embodiments, the compute engine 222 may compare matching rates between inferred image data generated by the at least one first sub-neural network model with inferred image data generated by each of a plurality of neural network models (and/or a plurality of sub-neural network models). The compute engine 222 may generate a model list by listing at least some of the plurality of neural network models (and/or the plurality of sub-neural network models) in a descending order of matching rates based on results of the comparison. The compute engine 222 may store the model list in the model storage 214 by mapping the model list to the at least one first sub-neural network model.

According to one or more embodiments, when there is a first replacement neural network model #1 that generates inferred image data having a matching rate greater than or equal to a second threshold value with respect to inferred image data generated by the at least one first sub-neural network model, the compute engine 222 may delete the at least one first sub-neural network model and link the first replacement neural network model #1 to the target neural network model. The compute engine 222 may generate at least a portion of first target inferred image data based on the first replacement neural network model #1.

According to one or more embodiments, during the process of generating inferred image data, when a number of times a target sub-neural network model from among at least one first sub-neural network models is used increases by a first threshold value or more, the compute engine 222 may divide the target sub-neural network model to generate at least one second sub-neural network model and store the second sub-neural network model in the model storage 214. The compute engine 222 may generate at least a portion of second target inferred image data based on the at least one second sub-neural network model. Here, the second target inferred image data may mean inferred image data generated by the target sub-neural network model.

According to one or more embodiments, when there is a first replacement neural network model #2 having a matching rate greater than or equal to a second threshold value with respect to inferred image data generated by the at least one second sub-neural network model, the compute engine 222 may delete the at least one second sub-neural network model and link the first replacement neural network model #2 to the target sub-neural network model. The compute engine 222 may generate at least a portion of second target inferred image data based on the first replacement neural network model #2.

According to one or more embodiments, the compute engine 222 may divide the target neural network model to generate at least one sub-neural network model (e.g., the at least one first sub-neural network model and/or the at least one second sub-neural network model) until a total data size, which is a sum of data sizes of the plurality of neural network models and data sizes of at least one sub-neural network model (e.g., the at least one first sub-neural network model and/or the at least one second sub-neural network model), reaches a data size allocated to the model storage 214.

According to one or more embodiments, when re-division of a target neural network model is needed (e.g., when new original image data is input and generation of a new sub-neural network model is needed), the compute engine 222 may delete at least one of sub-neural network models (e.g., the at least one first sub-neural network model and/or the at least one second sub-neural network model) of which a number of times of use is less than a third threshold value among at least one first sub-neural network model (or at least one second sub-neural network model) and re-divide the target neural network model to generate new sub-neural network models (e.g., at least one first sub-neural network model and/or at least one second sub-neural network model).

According to one or more embodiments, during the process of generating inferred image data, when a number of times of use of at least one of sub-neural network models from among the at least one first sub-neural network model and the at least one second sub-neural network model decreases below the third threshold value due to an increase in a number of times of use of a second replacement neural network model, the compute engine 222 may delete the at least one of the sub-neural network models (e.g., the at least one of the first sub-neural network model and/or the at least one of the second sub-neural network model) and link the second replacement neural network model to the target neural network model (or the target sub-neural network model). The compute engine 222 may generate at least a portion of first target inferred image data (or second target inferred image data) based on the second replacement neural network model. The compute engine 222 may re-divide the target neural network model (or the target sub-neural network model) simultaneously as deleting the at least one of sub-neural network models (e.g., the at least one first sub-neural network model and/or the at least one second sub-neural network model).

According to one or more embodiments, when at least a portion of the plurality of neural network models and at least one sub-neural network model are lost and a lost neural network model occurs, the compute engine 222 may select at least one recovery neural network model from among the plurality of neural network models and the at least one sub-neural network model based on a model list of the lost neural network model and recover the lost neural network model by using the at least one recovery neural network model.

According to one or more embodiments, when the model list of the lost neural network model is lost, the compute engine 222 may select a linked neural network model linked to the lost neural network model as at least one restored neural network model. The compute engine 222 may recover the lost neural network model by using the selected at least one recovery neural network model.

According to one or more embodiments, when the model list of the lost neural network model is lost and a linked neural network model linked to the lost neural network model is also lost, the compute engine 222 may select at least one recovery neural network model from among a plurality of neural network models and at least one sub-neural network model based on the model list of the linked neural network model. The compute engine 222 may recover the lost neural network model by using the selected at least one recovery neural network model.

According to one or more embodiments, when the model list of the lost neural network model is lost and the linked neural network model and the model list of the linked neural network model are also lost, the compute engine 222 may identify at least one model list including the linked neural network model from among the entire model lists stored in the model storage 214 and, based on the at least one model list, select a neural network model that generates inferred image data having a highest matching rate with inferred image data generated by the linked neural network model as at least one recovery neural network model. For example, the compute engine 222 may select a model list in which the linked neural network model is ranked with a highest priority from among the at least one model list and select a neural network model (or a sub-neural network model) corresponding to the selected model list as the at least one recovery neural network model. The compute engine 222 may recover the lost neural network model by using the selected at least one recovery neural network model.

According to one or more embodiments, the compute engine 222 may recover the lost neural network model (or the lost sub-neural network model) based on the selected at least one recovery neural network model.

The storage device 210 may include the storage controller 211, a buffer memory 212, and the NVM 213.

The storage controller 211 may manage the overall operation of the storage device 210 and control the NVM 213 such that an operation according to a request received from the host device 100 is performed. For example, the storage controller 211 may control the NVM 213 such that data is written to the NVM 213 or data is read from the NVM 213 in response to a write request or a read request from the host device 100 and may control an erase operation of the NVM 213. Also, the storage controller 211 may manage main operations of the NVM 213, such as garbage collection, bad block management, read reclaim, and read replacement, and may manage power of the NVM 213.

The buffer memory 212 may operate as a buffer that temporarily stores data within the storage device 210. The buffer memory 212 may store data received from the host device 100 or data read from the NVM 213. Also, the buffer memory 212 may store data generated by the computing device 220.

The buffer memory 212 may be implemented with a VM such as a DRAM, an SRAM, etc. However, the disclosure is not limited thereto, and the buffer memory 212 may be implemented with various types of NVMs, e.g., a resistive NVM such as magnetic RAM (MRAM), a phase change RAM (PRAM), or a resistive RAM (ReRAM), a flash memory, a nano floating gate memory (NFGM), a polymer RAM (PoRAM), or a ferroelectric RAM (FRAM). According to the present embodiment, the buffer memory 212 is illustrated as being provided outside the storage controller 211, but the disclosure is not limited thereto, and the buffer memory 212 may be provided inside the storage controller 211.

The NVM 213 may store data. The NVM 213 may store data provided from the host device 100 or data provided from the computing device 220. The NVM 213 may include a memory cell array including NVM cells capable of retaining stored data even when power to the storage device 210 is interrupted, and the memory cell array may be divided into a plurality of memory blocks. The plurality of memory blocks may have a two-dimensional horizontal structure in which NVM cells are arranged two-dimensionally on a same plane (or layer) or a three-dimensional vertical structure in which NVM cells are arranged three-dimensionally. A memory cell may be a single-level cell (SLC), which stores one bit of data, or a multi-level cell (MLC), which stores more than two bits of data. However, the disclosure is not limited thereto, and each memory cell may be a triple level cell (TLC) storing 3 bits of data or a quadruple level cell storing 4 bits of data.

The NVM 213 may include a plurality of dies each including a memory cell array MCA or include a plurality of chips. For example, the NVM 213 may include a plurality of chips, and the plurality of chips may each include a plurality of dies. According to one or more embodiments, the NVM 213 may also include a plurality of channels each including a plurality of chips.

The NVM 213 may be a NAND flash memory device. However, the disclosure is not limited thereto, and the NVM 213 may be implemented with resistive memory devices such as an ReRAM, a PRAM, and an MRAM.

According to one or more embodiments, the storage controller 211 may receive, from the interface 221 of the computing device 220 using an access protocol, a storage request for storing base data, an event table, and a neural network model and the base data, the event table, and the neural network model. The storage controller 211 may store the base data, the event table, and the neural network model in the NVM 213 in response to the storage request for storing the base data, the event table, and the neural network model using the access protocol received from the computing device 220.

According to one or more embodiments, the storage controller 211 may receive a storage request for storing original image data and the original image data using an access protocol from the interface 221 of the computing device 220. The storage controller 211 may store the original image data in the NVM 213 in response to the storage request for storing the original image data received from the computing device 220 using the access protocol.

According to one or more embodiments, the storage controller 211 may receive at least one sub-neural network model, which is generated by dividing a neural network model, using the access protocol from the interface 221 of the computing device 220. The storage controller 211 may store the at least one sub-neural network model in the NVM 213 (e.g., the model storage 214) in response to the neural network model division request received from the computing device 220 using an access protocol.

According to one or more embodiments, the storage controller 211 may receive a recovered neural network model (or at least one recovered sub-neural network model) by using the access protocol, from the interface 221 of the computing device 220. The storage controller 211 may store a neural network model (or at least one sub-neural network model) recovered by the computing device 220 in the NVM 213 (e.g., the model storage 214) in response to the data (e.g., neural network model) recovery request received from the computing device 220 using an access protocol.

According to one or more embodiments, some of the operations (or some of the components) of the computational storage system 200 described with reference to FIGS. 1 and 2 above may be implemented as operations (or components) of the host device 100.

For example, according to one or more embodiments, the host device 100 may generate base data and a corresponding event table from original image data in response to reception of a request from a user or generation of the original image data. The host device 100 may generate at least one region-specific (or at least one section-specific) neural network model based on at least one region-specific (or at least one section-specific) base data and event table. According to one or more embodiments, when a user's request is received or original image data is input to the computational storage system 200, the computational storage system 200 may receive base data, an event table, and a neural network model for each region (or base data, an event table, and a neural network model for each section) from the host device 100, and the computational storage system 200 may generate inferred image data for each region (or each section), based on the base data, the event table, and the neural network model.

For example, according to one or more embodiments, during the process of generating inferred image data, when the number of times a target neural network model from among a plurality of neural network models is used increases by a first threshold value or more, the host device 100 may divide the target neural network model to generate at least one first sub-neural network model and store the at least one first sub-neural network model in the computational storage system 200 (e.g., the model storage 214). At this time, the host device 100 may divide the target neural network model to generate at least one sub-neural network model until the total data size of the plurality of neural network models and the at least one sub-neural network model reaches a data size allocated to the model storage 214. Also, the host device 100 may compare matching rates between inferred image data generated by the at least one first sub-neural network model with inferred image data generated by each of a plurality of neural network models (and/or remaining sub-neural network models) and generate a model list by listing the plurality of neural network models (and/or remaining sub-neural network models) in a descending order of matching rates. The host device 100 may map and store at least one first sub-neural network model and a corresponding model list in the computational storage system 200 (e.g., the model storage 214).

For example, according to one or more embodiments, when at least one of the plurality of neural network models and at least one sub-neural network model are lost and a lost neural network model occurs, the host device 100 may select at least one recovery neural network model from among the plurality of neural network models and the at least one sub-neural network model based on a model list of the lost neural network model and recover the lost neural network model by using the at least one recovery neural network model. When the model list of the lost neural network model is lost, the host device 100 may recover the lost neural network model by selecting at least one linked neural network model linked to the lost neural network model as a recovery neural network model.

In this way, by using the computational storage system 200 according to one or more embodiments, the computing device 220 may generate inferred image data corresponding to original image data by using base data and an event table using a neural network model. Therefore, according to one or more embodiments, the computational storage system 200 may store a neural network model, base data, and an event table with relatively small data sizes instead of original image data with a large data size, thereby maximizing the utilization of the storage space in the storage device 210 and enabling efficient management.

Also, according to one or more embodiments, even when at least a portion of data (e.g., at least one of neural network models and/or sub-neural network models) of the storage device 210 is lost due to an unexpected event or accident, the computational storage system 200 may smoothly recover lost data (e.g., a lost neural network model/sub-neural network model) by dividing a main neural network model and storing divided neural network models as at least one sub-neural network model during the process of generating inferred image data. In other words, the computational storage system 200 according to one or more embodiments may manage data more safely.

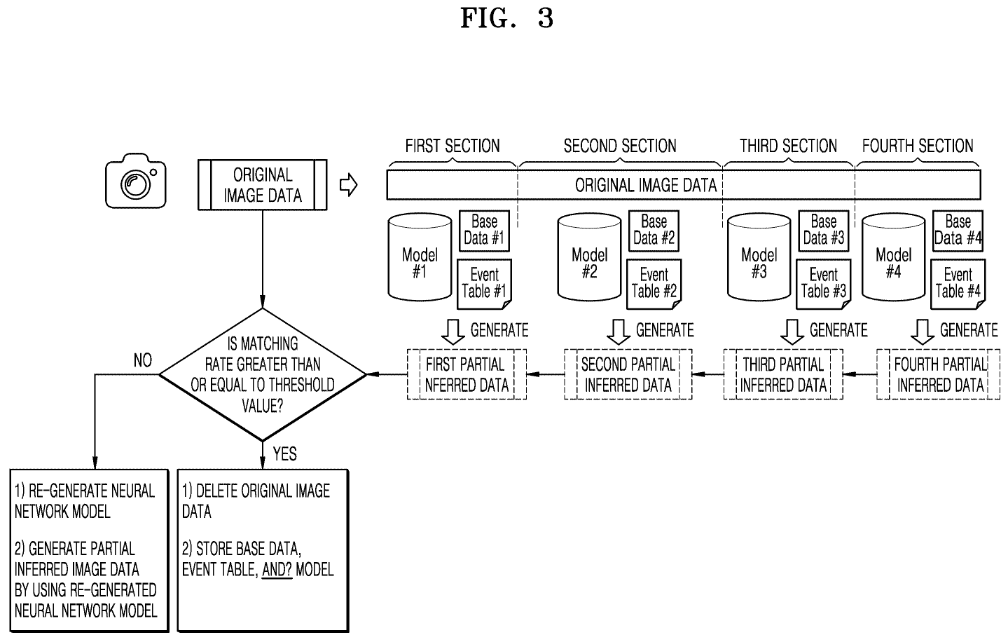

FIG. 3 is a diagram illustrating the operation of a computational storage system, according to one or more embodiments.

In detail, FIG. 3 is a diagram illustrating an operation of the computing device 220 of the computational storage system 200 for dividing original image data into at least one section (or at least one region) to generate at least one neural network model and an operation of comparing a matching rate between inferred image data generated by at least one neural network model with the original image data.

Referring to FIG. 3, according to one or more embodiments, the computing device 220 of the computational storage system 200 may receive original image data captured using an imaging device (e.g., a camera) from an external device (e.g., the host device 100).

According to one or more embodiments, the computing device 220 may divide the original image data into at least one section (or at least one region) based on whether the data size of an event table increases by a first threshold value (e.g., 200%) or more. For example, the computing device 220 may divide the original image data into first to fourth sections (or first to fourth regions (not shown)) based on whether the data size of the event table in the original image data increases by the threshold value (e.g., 200%) or more.

According to one or more embodiments, the computing device 220 may generate a neural network model for each section (or region) based on base data and an event tables corresponding to each section (or region). For example, the computing device 220 may generate a first neural network model Model #1 corresponding to a first section (or a first region), based on first base data Base data #1 and a first event table Event table #1 of the first section (or the first region) of the original image data. For example, the computing device 220 may generate a second neural network model Model #2 corresponding to a second section (or a second region), based on second base data Base data #2 and a second event table Event table #2 of the second section (or the second region) of the original image data. For example, the computing device 220 may generate a third neural network model Model #3 corresponding to the third section (or third region), based on third base data Base data #3 and a third event table Event table #3 of the third section (or third region) of the original image data. For example, the computing device 220 may generate a fourth neural network model Model #4 corresponding to the fourth section (or fourth region), based on fourth base data Base data #4 and a fourth event table Event table #4 of the fourth section (or fourth region) of the original image data.

According to one or more embodiments, the computing device 220 may generate section-specific inferred image data using a neural network model corresponding to each of the sections (or regions). For example, the computing device 220 may generate first partial inferred image data PIVD #1 corresponding to the first section (or the first region), based on the first base data Base data #1 and the first event table Event table #1 of the first section (or the first region), using the first neural network model Model #1. For example, the computing device 220 may generate second partial inferred image data PIVD #2 corresponding to the second section (or the second region), based on the second base data Base data #2 and the second event table Event table #2 of the second section (or the second region), using the second neural network model Model #2. For example, the computing device 220 may generate third partial inferred image data PIVD #3 corresponding to the third section (or the third region), based on the third base data Base data #3 and the third event table Event table #3 of the third section (or the third region), using the third neural network model Model #3. For example, the computing device 220 may generate fourth partial inferred image data PIVD #4 corresponding to the fourth section (or the fourth region), based on the fourth base data Base data #4 and the fourth event table Event table #4 of the fourth section (or the fourth region), using the fourth neural network model Model #4.

According to one or more embodiments, the computing device 220 may calculate a matching rate between the original image data and each partial inferred image data and determine whether the matching rate is greater than or equal to a threshold value (e.g., 80%). Here, the matching rate may indicate a degree of image matching between the original image data and each partial inferred image data based on the features of image data (e.g., changes in an object, changes in the object's concentration and color, etc.).

According to one or more embodiments, when the matching rate is greater than or equal to the threshold value (e.g., 80%), the computing device 220 may delete the original image data and store the base data, the event table, and the neural network model of the corresponding section in the storage device 210 instead of the original image data.

According to one or more embodiments, the computing device 220 may re-generate the neural network model of the section when the matching rate is less than the threshold value (e.g., 80%). For example, the computing device 220 may re-generate the neural network model by resetting sections of the original image data (e.g., changing the base data and the event table). The computing device 220 may generate partial inferred image data by using the re-generated neural network model.

As described above, the computational storage system 200 (or the computing device 220) according to one or more embodiments may calculate a matching rate indicating a degree of matching between original image data and inferred image data and, when the matching rate is less than the threshold value (e.g., 80%), a neural network model may be re-generated based on base data and an event table (e.g., the neural network model may be re-trained based on the base data and the event table).

Although FIG. 3 illustrates an operation of generating inferred image data based on at least one section-specific (e.g., the first to fourth sections) neural network model for convenience of explanation, the disclosure is not limited thereto, and the computational storage system 200 (or the computing device 220) according to one or more embodiments may generate inferred image data based on at least one region-specific neural network model.

Therefore, the computational storage system 200 according to one or more embodiments may store a neural network model, base data, and an event table (e.g., having small data sizes) instead of original image data (e.g., having large data size), thereby maximizing the utilization of the storage space.

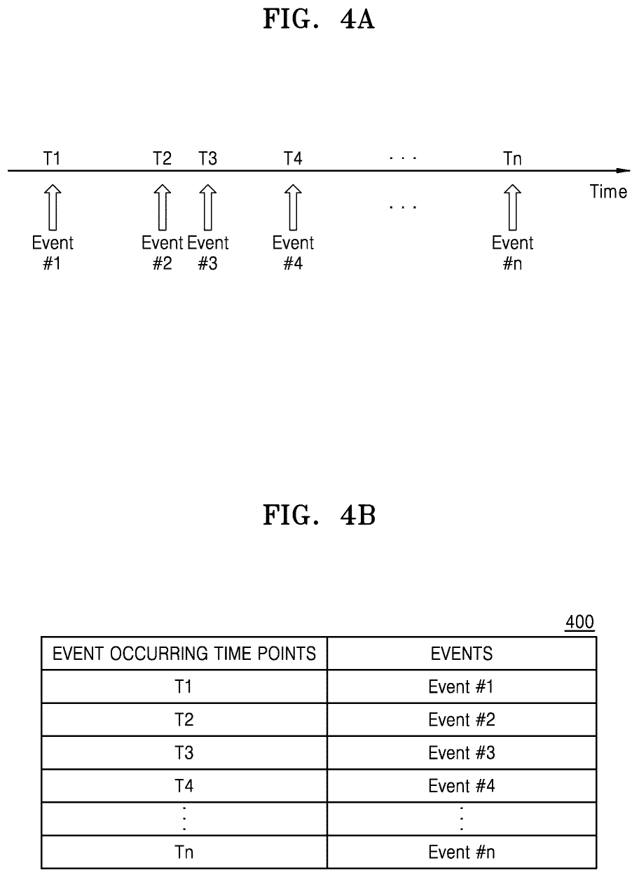

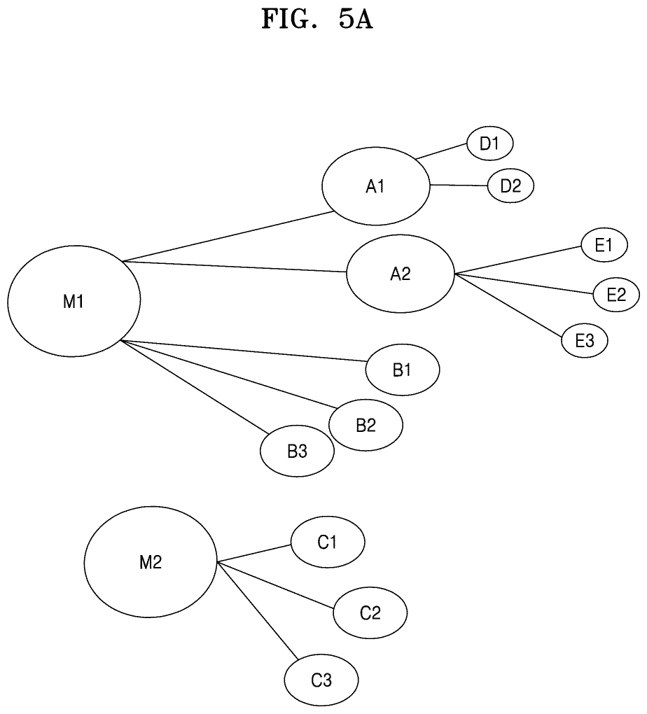

FIG. 4A is a diagram illustrating the operation of a computational storage system, according to one or more embodiments. FIG. 4B is a diagram illustrating an example of an event table of a computational storage system according to one or more embodiments.

In detail, FIG. 4A is a diagram illustrating an operation of generating an event table by the computing device 220 of the computational storage system 200, and FIG. 4B illustrates an example of an event table 400 generated by the computing device 220 in FIG. 4A.

Referring to FIG. 4A, a timeline listing each event in a chronological order of occurrence, for a plurality of events (e.g., movement of an object (or a change in position coordinates of the object), a change in motion, a change in weather (e.g., change in illuminance, change in climate, change in precipitation), an appearance of a new object, a change in color and/or tone of an object, etc.) occurring in base data included in at least one region and/or section of original image data. For example, a first event Event #1 may occur at a first time point T1, a second event Event #2 may occur at a second time point T2, a third event Event #3 may occur at a third time point T3, a fourth event Event #4 may occur at a fourth time point T4, . . . , and an n-th event Event #n may occur at an n-th time point Tn.

Referring to FIGS. 4A and 4B, the computing device 220 may generate the event table 400 by mapping a plurality of events to respective occurrence times thereof. For example, the computing device 220 may generate the event table 400 by mapping the first event Event #1 to the first time point T1, which is the occurrence time of the first event Event #1, mapping the second event Event #2 to the second time point T2, which is the occurrence time of the second event Event #2, mapping the third event Event #3 to the third time point T3, which is the occurrence time of the third event Event #3, mapping the fourth event Event #4 to the fourth time point T4, which is the occurrence time of the fourth event Event #4, . . . , and mapping the n-th event Event #n to the n-th time point Tn, which is the occurrence time of the n-th event Event #n.

FIGS. 5A to 5D are diagrams illustrating the operation of a computational storage system, according to one or more embodiments.

In detail, FIGS. 5A to 5D are diagrams illustrating an operation of generating at least one sub-neural network model by dividing a neural network model by the computing device 220 of the computational storage system 200.

Referring to FIG. 5A, the computing device 220 according to one or more embodiments may generate at least one first sub-neural network model A1, A2, B1, B2, and B3 by dividing a target neural network model #1 M1 when a number of times the target neural network model #1 M1 is used increases by a first threshold value or more during the process of generating inferred image data. The computing device 220 may store the at least one first sub-neural network model A1, A2, B1, B2, and B3 in the model storage (e.g., 214 in FIG. 2). The computing device 220 may generate at least a portion of first target inferred image data #1 based on the at least one first sub-neural network model A1, A2, B1, B2, and B3. Here, the first target inferred image data #1 may mean inferred image data generated by the target neural network model #1 M1. For example, a first sub-neural network model #1 A1 may generate inferred image data for a first section (or a first region) of the first target inferred image data #1, and a first sub-neural network model #2 A2 may generate inferred image data for a second section (or a second region) of the first target inferred image data #1. A first sub-neural network model #3 B1 may generate inferred image data for a third section (or a third region) of the first target inferred image data #1, a first sub-neural network model #4 B2 may generate inferred image data for a fourth section (or a fourth region) of the first target inferred image data #1, and a first sub-neural network model #5 B3 may generate inferred image data for a fifth section (or a fifth region) of the first target inferred image data #1. According to one or more embodiments, when a number of times a target neural network model #2 M2 is used increases by the first threshold value or more during the process of generating inferred image data, the computing device 220 may divide the target neural network model #2 M2 to generate at least one first sub-neural network model C1, C2, and C3. The computing device 220 may store the at least one first sub-neural network model C1, C2, and C3 in the model storage (e.g., 214 in FIG. 2). The computing device 220 may generate at least a portion of first target inferred image data #2 based on the at least one first sub-neural network model C1, C2, and C3. Here, the first target inferred image data #2 may mean inferred image data generated by the target neural network model #2 M2. For example, a first sub-neural network model #6 C1 may generate inferred image data for a first section (or a first region) of the first target inferred image data #2, a first sub-neural network model #7 C2 may generate inferred image data for a second section (or a second region) of the first target inferred image data #2, and a first sub-neural network model #8 C3 may generate inferred image data for a third section (or a third region) of the first target inferred image data #2.

According to one or more embodiments, the computing device 220 may compare a matching rate between inferred image data generated by the first sub-neural network model #1 A1 with inferred image data generated by each of a plurality of neural network models (e.g., M1, M2, etc.) and at least one first sub-neural network model (e.g., A2, B1, B2, B3, C1, C2, C3, etc.). The computing device 220 may list up at least some of the plurality of neural network models (e.g., M1, M2, etc.) (and/or the at least one first sub-neural network model (e.g., A2, B1, B2, B3, C1, C2, C3, etc.)) in the descending order of matching rates based on results of the comparison and generate a model list #1 corresponding to the first sub-neural network model #1 A1. The computing device 220 may generate a model list corresponding to each of remaining sub-neural network models (e.g., A2, B1, B2, B3, C1, C2, C3, etc.) by using the method described above.

According to one or more embodiments, the computing device 220 may map the first sub-neural network model #1 A1 to the model list #1 corresponding thereto and store them in the model storage (e.g., 214 in FIG. 2), map the first sub-neural network model #2 A2 to a model list #2 corresponding thereto and store them in the model storage (e.g., 214 in FIG. 2), map the first sub-neural network model #3 B1 and a model list #3 corresponding thereto and store them in the model storage (e.g., 214 in FIG. 2), map the first sub-neural network model #4 B2 to a model list #4 corresponding thereto and store them in the model storage (e.g., 214 in FIG. 2), and map the first sub-neural network model #5 B3 to a model list #5 corresponding thereto and store them in the model storage (e.g., 214 in FIG. 2). The computing device 220 may map the first sub-neural network model #6 C1 to a model list #6 corresponding thereto and store them in the model storage (e.g., 214 in FIG. 2), map the first sub-neural network model #7 C2 to a model list #7 corresponding thereto and store them in the model storage (e.g., 214 in FIG. 2), and map the first sub-neural network model #8 C3 to a model list #8 corresponding thereto and store them in the model storage (e.g., 214 in FIG. 2).

According to one or more embodiments, in the computing device 220, during the process of generating inferred image data, when the number of times a target sub-neural network model #1 (assuming that the first sub-neural network model #1 A1 is the target sub-neural network model #1 from among at least one first sub-neural network model A1, A2, B1, B2, B3, C1, C2, C3, etc.) increases by the first threshold value or more, the target sub-neural network model #1 may be divided to generate at least one second sub-neural network model D1 and D2, and the at least one second sub-neural network model D1 and D2 may be stored in the model storage (e.g., 214 in FIG. 2). The computing device 220 may generate at least a portion of second target inferred image data #1 based on the at least one second sub-neural network model D1 and D2. Here, the second target inferred image data #1 may mean inferred image data generated by the target sub-neural network model #1. For example, a second sub-neural network model #1 D1 may generate inferred image data for a first section (or a first region) of the second target inferred image data #1, and a second sub-neural network model #2 D2 may generate inferred image data for a second section (or a second region) of the second target inferred image data #1.

According to one or more embodiments, in the computing device 220, during the process of generating inferred image data, when the number of times a target sub-neural network model #2 (assuming that the first sub-neural network model #2 A2 is the target sub-neural network model #2 from among at least one first sub-neural network model A1, A2, B1, B2, B3, C1, C2, C3, etc.) increases by the first threshold value or more, the target sub-neural network model #2 may be divided to generate at least one second sub-neural network model E1, E2, and E3, and the at least one second sub-neural network(s) model E1, E2, and E3 may be stored in the model storage (e.g., 214 in FIG. 2). The computing device 220 may generate at least a portion of second target inferred image data #2 based on the at least one second sub-neural network model E1, E2, and E3, and C3. Here, the second target inferred image data #2 may mean inferred image data generated by the target sub-neural network model #2. For example, a second sub-neural network model #3 E1 may generate inferred image data for a first section (or a first region) of the second target inferred image data #2, a second sub-neural network model #4 E2 may generate inferred image data for a second section (or a second region) of the second target inferred image data #2, and a second sub-neural network model #5 E3 may generate inferred image data for a third section (or a third region) of the second target inferred image data #2.

According to one or more embodiments, the computing device 220 may generate at least one sub-neural network model (e.g., first to n-th sub-neural network models (wherein n is an integer greater than or equal to 1)) by dividing the target neural network model #1 M1 or the target neural network model #2 M2 until the data size of the entire neural network models including a plurality of neural network models M1 and M2 and at least one sub-neural network model (e.g., the first to n-th sub-neural network models, etc.) reaches a data size allocated to the model storage 214.

Referring to FIG. 5B, according to one or more embodiments, the computing device 220 may compare matching rates between inferred image data generated by the second sub-neural network model #2 D2 (after the second sub-neural network model #2 D2 is generated) and inferred image data generated by each of a plurality of neural network models (e.g., M1, M2, etc.) and at least one of first to second sub-neural network models (e.g., A1, A2, B1, B2, B3, . . . , E1, E2, E3, etc.). When there is a first replacement neural network model (e.g., the second sub-neural network model #3 E1) that generates inferred image data having a matching rate greater than or equal to the second threshold value based on results of the comparison, the computing device 220 may delete the second sub-neural network model #2 D2 and link the second sub-neural network model #3 E1, which is the first replacement neural network model, to the target sub-neural network model #1. The computing device 220 may generate at least a portion of second target inferred image data generated by the target sub-neural network model #1 based on the second sub-neural network model #3 E1, which is the first replacement neural network model.

Referring to FIG. 5C, according to one or more embodiments, when re-division of a target neural network model (or a target sub-neural network model #3) is needed, the computing device 220 may delete the first sub-neural network model #8 C3 from among at least one sub-neural network model A1, A2, . . . , E1, E2, E3, of which the number of times of use is less than the third threshold value, and re-divide the target sub-neural network model C1 to generate at least one second sub-neural network model (e.g., a second sub-neural network model #6 F1 and a second sub-neural network model #7 F2) (NEW) (here, the target neural network model is assumed to be neural network model #2 M2, and the target sub-neural network model #3 is assumed to be the first sub-neural network model #6 C1). The computing device 220 may store the at least one second sub-neural network model (e.g., the second sub-neural network model #6 F1 and the second sub-neural network model #7 F2) in the model storage 214. The computing device 220 may generate at least a portion of second target inferred image data generated by the target sub-neural network model #3 based on the at least one second sub-neural network model (e.g., the second sub-neural network model #6 F1 and the second sub-neural network model #7 F2). Here, the re-division of the target sub-neural network model #3 (e.g., the first sub neural network model #6 C1) may correspond to the re-division of the target neural network model (e.g., neural network model M2). Also, when re-division of the target neural network model (or the target sub-neural network model #3) is needed, it may be the case that new original image data is input to the computational storage system 200 and a new neural network model needs to be generated.

Referring to FIG. 5D, according to one or more embodiments, when the number of times of use of the first sub-neural network model #8 C3 from among at least one sub-neural network model A1, A2, . . . , E1, E2, and E3 decreases below the third threshold value due to an increase in the number of times of use of the first sub-neural network model #5 B3, which is a second replacement neural network model, the computing device 220 may delete the first sub-neural network model #8 C3 and link the target neural network model (e.g., the neural network model M2) to the first sub-neural network model #5 B3, which is the second replacement neural network model. The computing device 220 may generate at least a portion of first inferred image data generated by the target neural network model (e.g., neural network model M2) based on the first sub-neural network model #5 B3, which is the second replacement neural network model. Additionally, the computing device 220 may re-divide the target neural network model M2 to generate a new sub-neural network model.

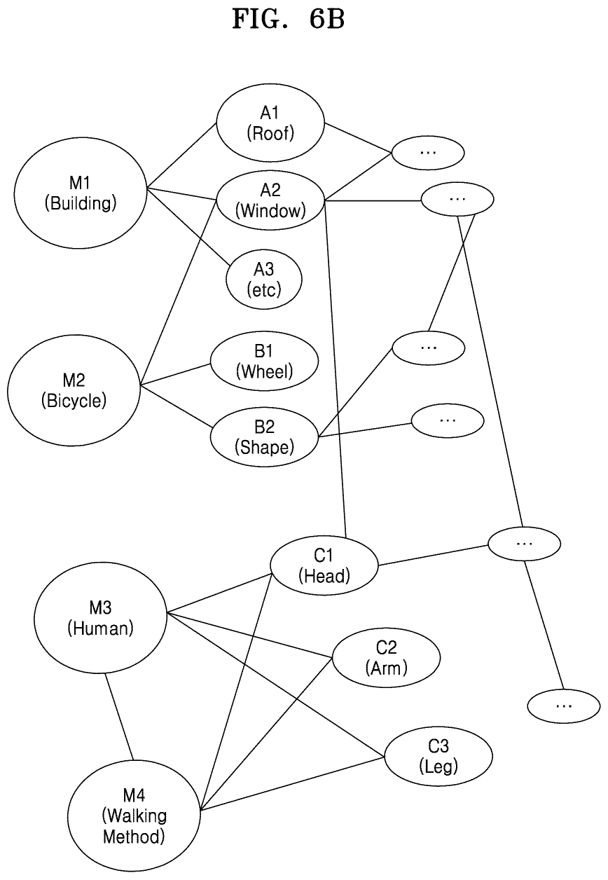

FIGS. 6A and 6B are diagrams illustrating the operation of a computational storage system, according to one or more embodiments.

In detail, FIGS. 6A and 6B are diagrams illustrating an operation of generating sub-neural network models by dividing neural network models of the computational storage system 200 (e.g., the computing device 220) when there is a request from the host device (e.g., 100 in FIG. 1) or when original image data is input.

Referring to FIG. 6a, a captured image 600 captured from original image data is illustrated. The captured image 600 may include various regions. For example, as illustrated in FIG. 6A, the captured image 600 may include a region including a ‘building’ (hereinafter referred to as a first region), a region including a ‘bicycle’ (hereinafter referred to as a second region), and a region including a ‘person’ (hereinafter referred to as a third region).

Referring to FIGS. 6A and 6B, the computing device 220 according to one or more embodiments may generate a neural network model for at least one region included in the original image data based on the captured image 600 captured from the original image data. For example, the computing device 220 may generate a neural network model #1 M1 corresponding to the first region (e.g., building) in the captured image 600, generate a neural network model #2 M2 corresponding to the second region (e.g., bicycle) in the captured image 600, and generate a neural network model #3 M3 corresponding to the third region (e.g., human) in the captured image 600. Additionally, the computing device 220 may generate a neural network model #4 M4 corresponding to a ‘human walking method’ of the third region as a derivative neural network model for the third region.

According to one or more embodiments, the computing device 220 may generate inferred image data corresponding to restored image data of each region based on base data and an event table using a neural network model for each region. For example, the computing device 220 may generate inferred image data corresponding to original image data of the first region by using the neural network model #1 M1 based on base data and an event table of the first region. The computing device 220 may generate inferred image data corresponding to original image data of the second region by using the neural network model #2 M2 based on base data and an event table of the second region. The computing device 220 may generate inferred image data corresponding to original image data of the third region by using the neural network model #3 M3 based on base data and an event table of the third region. The computing device 220 may generate inferred image data corresponding to original image data of the third region by using the neural network model #4 M4 based on base data and an event table of the third region regarding human waking method.

According to one or more embodiments, when a degree of reference to a target neural network model increases by a first threshold value or more during the process of generating inferred image data, the computing device 220 may divide the target neural network model to generate at least one sub-neural network model. Here, the at least one sub-neural network model may be a neural network model that generates inferred image data for an object included in a region corresponding to the target neural network model. For example, when the target neural network model is the neural network model #1 M1, which corresponds to the first region (e.g., building) in the captured image 600, the computing device 220 may generate a first sub-neural network model #1 A1 (e.g., corresponding to a roof of the building) that generates inferred image data for a ‘roof’ of the first region by dividing the neural network model #1 M1, generate a first sub-neural network model #2 A2 (e.g., corresponding to a window of the building) that generates inferred image data for a ‘window’ of the first region by dividing the neural network model #1 M1, and generate a first sub-neural network model #3 A3 (corresponding to other object(s) of the building) that generates inferred image data for ‘other object(s)’ of the first region by dividing the neural network model #1 M1. For example, when the target neural network model is the neural network model #2 M2, which corresponds to the second region (e.g., bicycle) in the captured image 600, the computing device 220 may generate a first sub-neural network model #4 B1 (e.g., corresponding to a wheel of the bicycle) that generates inferred image data for a ‘wheel’ of the second region by dividing the neural network model #2 M2 and may generate a first sub-neural network model #5 B2 (e.g., corresponding to a shape of the bicycle) that generates inferred image data for a ‘shape’ of the second region by dividing the neural network model #2 M2. For example, when the target neural network model is the neural network model #3 M3, which corresponds to the third region (e.g., human) in the captured image 600, the computing device 220 may generate a first sub-neural network model #6 C1 (e.g., corresponding to a head of the human) that generates inferred image data for the ‘head’ of the third region by dividing the neural network model #3 M3, generate a first sub-neural network model #7 C2 (e.g., corresponding an arm of the human) that generates inferred image data for the ‘arm’ of the third region by dividing the neural network model #3 M3, and generate a first sub-neural network model #8 C3 (e.g., corresponding to a leg of the human) that generates inferred image data for the ‘leg’ of the third region by dividing the neural network model #3 M3. Referring to FIG. 6B, an example of a tree structure of a neural network model generated by the computing device 220 is illustrated. However, the disclosure is not limited thereto, and the computing device 220 according to one or more embodiments may generate a tree structure of various forms of neural network models.

According to one or more embodiments, when there is another sub-neural network model (e.g., a replacement neural network model) whose matching rate with the inferred image data generated by a given sub-neural network model is greater than or equal to the second threshold value, the computing device 220 may delete the given sub-neural network model and link the other sub-neural network model (e.g., a replacement neural network model) to the target neural network model. For example, when there is the first sub-neural network model #6 C1 (e.g., a replacement neural network model), which has a matching rate greater than or equal to the second threshold value and is generated by a sub-neural network model #9 (not shown) generated by dividing the neural network model #4 M4, the computing device 220 may delete the sub-neural network model #9 (not shown) and link the first sub-neural network model #6 C1 (e.g., a replacement neural network model) to the neural network model #4 M4, which is a target neural network model. According to the method described above, the computing device 220 may link the first sub-neural network model #7 C2 and the first sub-neural network model #8 C3 to the neural network model #4 M4, which is the target neural network model.

According to one or more embodiments, the computing device 220 may classify storage reliability according to importance of each of at least one sub-neural network model and store the at least one sub-neural network model in the model storage (e.g., 214 in FIG. 2) according to the storage reliability thereof. Therefore, the computing device 220 may smoothly recover a sub-neural network model with high storage reliability (e.g., an important sub-neural network model) even when data in the storage device 210 becomes lost.

As described above, the computational storage system 200 (or the computing device 220) according to one or more embodiments may divide a neural network model (e.g., the neural network model #1 M1 to the neural network model #3 M3, etc.) of original image data to generate at least one sub-neural network model (e.g., the first sub-neural network model #1 A1 to the first sub-neural network model #8 C3, etc.). The computational storage system 200 (or the computing device 220) may efficiently manage the storage space by generating inferred image data through cross-referencing between a neural network model and at least one sub-neural network model.

Also, the computational storage system 200 (or the computing device 220) according to one or more embodiments may separately store not only a neural network model (e.g., the neural network model #1 M1 to the neural network model #3 M3, etc.) but also at least one sub-neural network model (e.g., the first sub-neural network model #1 A1 to the first sub-neural network model #8 C3, etc.) generated by dividing the neural network model, and thus, even when data in a storage device is lost due to an unexpected event or accident, the data may be smoothly recovered.

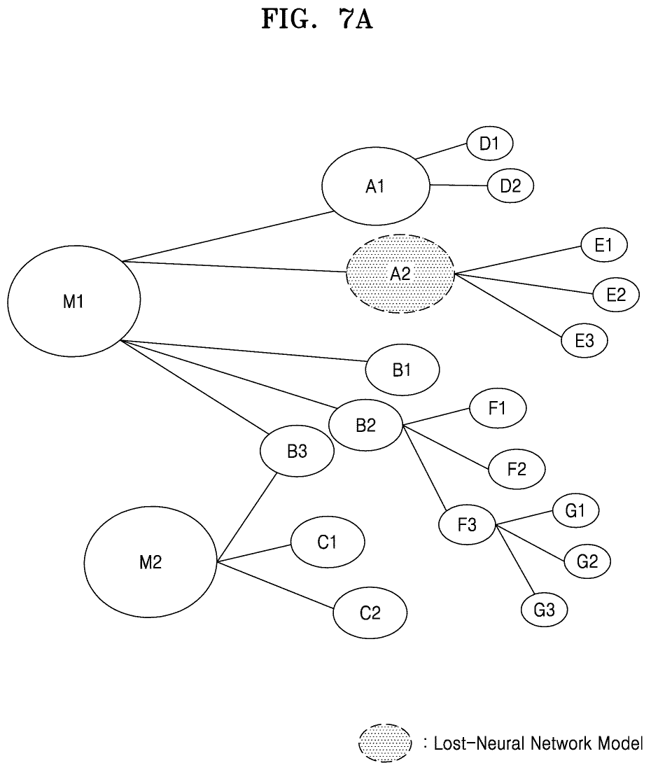

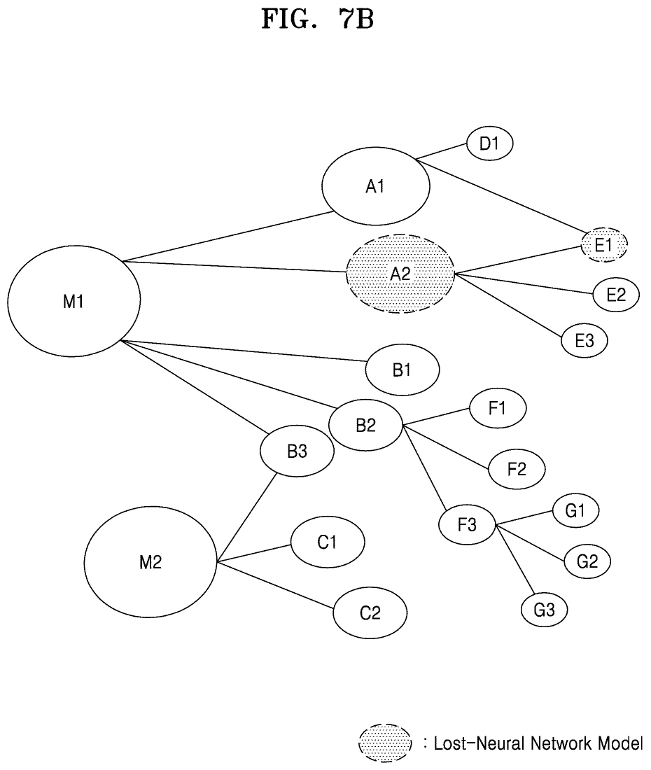

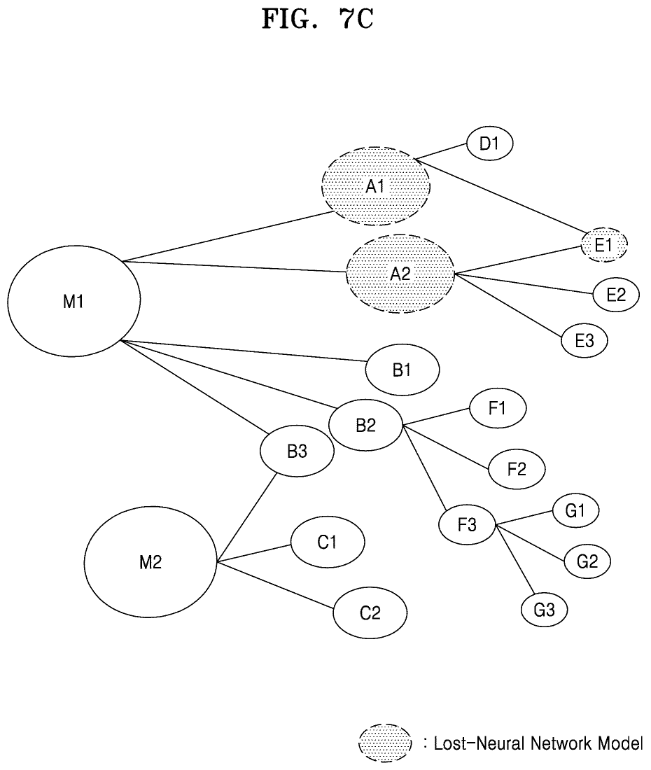

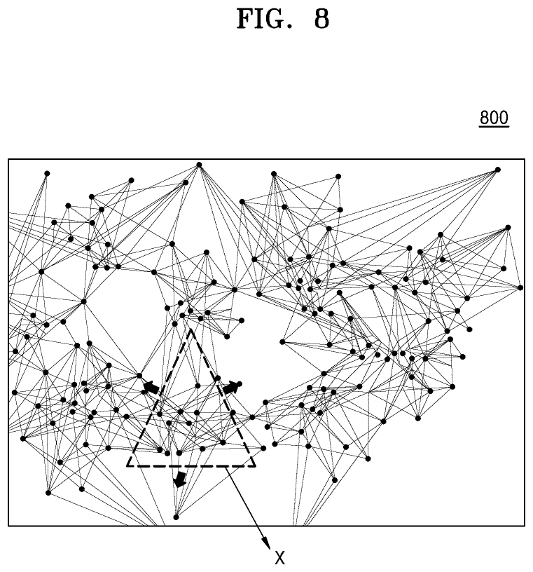

FIGS. 7A to 7C are diagrams illustrating the operation of a computational storage system, according to one or more embodiments.

In detail, FIGS. 7A to 7C are diagrams illustrating an operation of generating at least one sub-neural network model by dividing a neural network model by the computing device 220 of the computational storage system 200. In FIGS. 7A to 7C, a circular neural network model with a dotted border indicates a lost neural network model (or a lost sub-neural network model).

In FIGS. 7A to 7C, it is assumed that the model storage (e.g., 214 in FIG. 2) of the computational storage system 200 stores a plurality of neural network models (e.g., the neural network model #1 M1 and the neural network model #2 M2) and a plurality of sub-neural network models (e.g., the first sub-neural network model #1 A1 to the first sub-neural network model #7 C2, the second sub-neural network model #1 D1 to a second sub-neural network model #8 F3, and a third sub-neural network model #1 G1 to a third sub-neural network model #3 G3, etc.). Also, in FIGS. 7A to 7C, it is assumed that the model storage (e.g., 214 in FIG. 2) of the computational storage system 200 stores model lists respectively corresponding to the plurality of sub-neural network. In this specification, a model list of a neural network model (or sub-neural network model) may mean a list in which remaining neural network models (and/or remaining sub-neural network models) are listed up according to matching rates by comparing the matching rates between inferred image data generated by the neural network model (or sub-neural network model) and inferred image data generated by each of the remaining neural network models (and/or the remaining sub-neural network models) at the time of generation (or division) of the sub-neural network model (e.g., the first sub-neural network model, the second sub-neural network model, etc.). In this specification, the first sub-neural network model may refer to a sub-neural network model generated by dividing a neural network model (e.g., any one of M1 and M2), the second sub-neural network model may refer to a sub-neural network model generated by dividing the first sub-neural network model (e.g., any one of A1 to C2), and the third sub-neural network model may refer to a sub-neural network model generated by dividing the second sub-neural network model (e.g., any one of D1 to F3).

In FIGS. 7A to 7C, it is assumed that, when an initially invoked neural network model (or an invoked sub-neural network model (e.g., A2)) is lost, a linked neural network model that is linked to the corresponding lost neural network model (or the corresponding lost sub-neural network model) is invoked. Also, when there are a plurality of model lists of invoked neural network models and/or invoked sub-neural network models, the computing device 220 may select at least one recovery neural network model based on a model list of the initially invoked neural network model (e.g., A2). When all of model lists of invoked neural network models and/or invoked sub-neural network models are lost (e.g., FIG. 7C), the computing device 220 may identify and/or search for at least one recovery neural network model based on a most recently invoked neural network model (or sub-neural network model) (e.g., A1 of FIG. 7C). However, the disclosure is not limited thereto, and the computing device 220 according to one or more embodiments may identify and/or search for at least one recovery neural network model based on various neural network models (or sub-neural network models) (e.g., a lost neural network model (or a lost sub-neural network model)), regardless of an invocation order thereof.

Referring to FIG. 7A, when the first sub-neural network model #2 A2 is lost, the computing device 220 according to one or more embodiments may select at least one recovery neural network model from among a plurality of neural network models M1 and M2 and a plurality of sub-neural network models e.g., A1, B1, B2,. G3, etc. based on the model list of the first sub-neural network model #2 A2, which is a lost neural network model. The computing device 220 may recover the first sub-neural network model #2 A2 by using at least one selected recovery neural network model.

According to one or more embodiments, the computing device 220 may select a linked neural network model linked to the first sub-neural network model #2 A2 as the at least one recovery neural network model when the first sub-neural network model #2 A2 is lost and the model list of the first sub-neural network model #2 A2 is also lost. For example, the computing device 220 may select at least one of the neural network model #1 M1 linked to the first sub-neural network model #2 A2 or at least one of a second sub-neural network model #3 E1 to a second sub-neural network model #5 E3 as at least one recovery neural network model. The computing device 220 may recover the first sub-neural network model #2 A2 by using at least one selected recovery neural network model.

Referring to FIG. 7B, when the first sub-neural network model #2 A2, the model list of the first sub-neural network model #2 A2, and a second sub-neural network model #2 E1 (e.g., a linked neural network model) linked to the first sub-neural network model #2 A2 are lost, the computing device 220 according to one or more embodiments may select at least one recovery neural network model from among the plurality of neural network models M1 and M2 and the plurality of sub-neural network models (e.g., A1, B1, B2, . . . , G3, etc.) based on a model list of the second sub-neural network model #2 E1, which is the linked neural network model. For example, it is assumed that the model list of the second sub-neural network model #2 E1 indicates a descending order of ‘A2>A1>E2,E3>M1>F1>C1>G3’. A model ranked to a higher rank in the model list (e.g., a model located on a left side of the descending order of the model list (e.g., A2)) may be a neural network model that generates inferred image data having a higher matching rate with inferred image data generated by the second sub-neural network model #2 E2. At this time, the second sub-neural network model #3 E2 and the second sub-neural network model #4 E3 generated through division from the same target neural network model A2 may have the same priority in the model list of the second sub-neural network model #2 E1. In other words, the second sub-neural network model #3 E2 and the second sub-neural network model #4 E3 located at the same level in a neural network model tree structure (refer to FIG. 7B) may have the same priority in the model list of the second sub-neural network model #2 E1. For example, based on the model list of the second sub-neural network model #2 E1 (since the first sub-neural network model #2 A2 having the highest priority is lost), the computing device 220 may select at least one from among the first sub-neural network model #1 A1, the second sub-neural network model #3 E2, the second sub-neural network model #4 E3, the neural network model #1 M1, the second sub-neural network model #5 F1, the first sub-neural network model #6 C1, the third sub-neural network model #3 G3, or a combination thereof as the at least one recovery neural network model. The computing device 220 may recover the first sub-neural network model #2 A2 and the second sub-neural network model #2 E1 by using at least one selected recovery neural network model.

Referring to FIG. 7C, when all of the first sub-neural network model #2 A2, the model list of the first sub-neural network model #2 A2, the second sub-neural network model #2 E1 (e.g., a first linked neural network model), the model list of the second sub-neural network model #2 E1, the first sub-neural network model #1 A1 (e.g., a second linked neural network model), and the model list of the first sub-neural network model #1 A1 are lost, the computing device 220 according to one or more embodiments may identify and/or search for at least one model list including the first sub-neural network model #2 A2, which is the most recently invoked sub-neural network model (e.g., the second linked neural network model), from among all of model lists stored in the model storage (e.g., 214 in FIG. 2). Based on the identified and/or searched at least one model list, the computing device 220 may select a neural network model that generates inferred image data having the highest matching rate with inferred image data generated by the first sub-neural network model #1 A1 as the at least one recovery neural network model. For example, the computing device 220 may identify a model list in which the first sub-neural network model #1 A1 is ranked at the highest priority from among the at least one model list and select a neural network model (or a sub-neural network model) corresponding to the selected model list as the at least one recovery neural network model. The computing device 220 may recover the first sub-neural network model #2 A2, the second sub-neural network model #2 E1, and the first sub-neural network model #1 A1 by using at least one selected recovery neural network model.

According to one or more embodiments, the computing device 220 may classify storage reliability according to importance of each of at least one sub-neural network model and store the at least one sub-neural network model in the model storage (e.g., 214 in FIG. 2). Therefore, the computing device 220 may smoothly recover a sub-neural network model with high storage reliability (e.g., an important sub-neural network model) even when data in the storage device 210 is lost in the future.

As described above, according to various embodiments, the computational storage system 200 (or the computing device 220) may manage data more safely by storing a neural network model by dividing the neural network model into at least one sub-neural network model.

Furthermore, even when data in a storage device is lost due to an unexpected event or accident, the lost data may be recovered by selecting at least one recovery neural network model based on the model list of a lost neural network model (or a lost sub-neural network model).

FIG. 8 is a diagram illustrating an example 800 of a structure of a neural network model and a sub-neural network model, according to one or more embodiments.

In FIG. 8, a single dot may represent a neural network model or a sub-neural network model, and a solid line interconnecting different points may represent a link between different neural network models (or sub-neural network models).

It is assumed that a triangular region X having a dotted border in FIG. 8 represents a region lost due to an event or accident. In other words, it is assumed that neural network models and sub-neural network models within the triangular region X having the dotted border are lost.

Referring to FIG. 8, the computing device 220 according to one or more embodiments may select at least one recovery neural network model based on the matching rate of a lost neural network model (or a lost sub-neural network model). According to one or more embodiments, the computing device 220 may select at least one recovery neural network model based on a linked neural network model (or a linked sub-neural network model) linked to the lost neural network model (or the lost sub-neural network model). According to one or more embodiments, the computing device 220 may select at least one recovery neural network model based on the model list of a linked neural network model (or a linked sub-neural network model) linked to the lost neural network model (or the lost sub-neural network model). According to one or more embodiments, the computing device 220 may identify a model list in which the lost neural network model (or the lost sub-neural network model) is ranked at the highest priority from among at least one model list stored in the storage device 210 and select a neural network model (or a sub-neural network model) corresponding to the identified model list as the at least one recovery neural network model. According to one or more embodiments, the computing device 220 may identify a model list in which a linked neural network model linked to the lost neural network model is ranked at the highest priority from among at least one model list stored in the storage device 210 and select a neural network model (or a sub-neural network model) corresponding to the identified model list as the at least one recovery neural network model.

The computing device 220 may recover the lost neural network model (or the lost sub-neural network model) based on the at least one recovery neural network model.

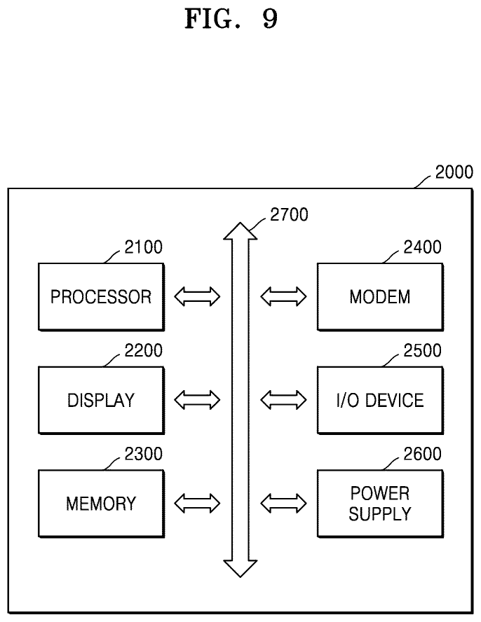

FIG. 9 is a block diagram illustrating an electronic device according to one or more other embodiments.

Referring to FIG. 9, an electronic device 2000 may include at least one processor 2100, a display 2200, at least one memory 2300, a modem 2400, an input/output device 2500, and a power supply 2600.

The at least one processor 2100 is a device that controls the overall operation of the electronic device 2000. The at least one processor 2100 may perform data processing on input data by executing an application. An application may include multiple data operations related to performing a task, such as arithmetic operations, convolution operations, and polling operations. For example, when the at least one processor 2100 performs a task based on a neural network (e.g., generation of inferred image data corresponding to original image data, generation of a sub-neural network model by dividing a neural network model, and recovery of a lost neural network model), an application may include a plurality of data operations based on at least one of various types of neural networks included in the application, and input, and output sizes, weights, and biases of the plurality of data operations. For example, the neural network model is a generative model and may be a deep-fake model.

The at least one processor 2100 may be implemented with a CPU, a graphics processing unit (GPU), a digital signal processor (DSP), a field programmable gate array (FPGA), an application specific integrated circuit (ASIC), a neural processing unit (NPU), etc. However, the disclosure is not limited thereto, and the at least one processor 2100 may be implemented with various types of circuits that perform data processing, such as data operations, demanded to perform assigned tasks in parallel.

The at least one processor 2100 according to one or more embodiments may divide original image data into at least one region (or at least one section) based on a pre-set criterion (e.g., whether the size of an event table increases by a threshold value (e.g., 200%) or more) and generate a neural network model corresponding to the at least one region or the at least one section.

The at least one processor 2100 according to one or more embodiments may generate inferred image data of a corresponding region (or a corresponding section) based on base data and an event table of the corresponding region (or the corresponding section) by using a generated neural network model. Here, the inferred image data may refer to data generated by inferring the original image data of the corresponding region (or the corresponding section).

According to one or more embodiments, when the number of times a target neural network model (or a target sub-neural network model) is used increases by a first threshold value or more during the process of generating inferred image data, the at least one processor 2100 may divide the target neural network model (or the target sub-neural network model) to generate at least one sub-neural network model and store the at least one sub-neural network model in the at least one memory 2300 (e.g., a model storage).

The at least one processor 2100 according to one or more embodiments may compare matching rates between inferred image data generated by at least one divided sub-neural network model and inferred image data generated by each of a plurality of neural network models and a plurality of sub-neural network models stored in the at least one memory 2300 and generate a model list by listing up the plurality of neural network models and the plurality of sub-neural network models in the descending order of matching rates. The at least one processor 2100 may map at least one sub-neural network model to a model list corresponding thereto and store them in the at least one memory 2300 (e.g., the model storage).

The at least one processor 2100 according to one or more embodiments may select at least one recovery neural network model based on a model list stored in the at least one memory 2300 (e.g., the model storage) when data (e.g., a neural network model and/or at least one sub-neural network model) in the at least one memory 2300 (e.g., the model storage) is lost due to an unexpected event or accident (e.g., when a lost neural network model occurs). According to one or more embodiments, when the model list of the lost neural network model is lost, the at least one processor 2100 may select a linked neural network model linked to the lost neural network model as the at least one restored neural network model. According to one or more embodiments, when the model list of a lost neural network model is lost and a linked neural network model linked to the lost neural network model and the model list of the linked neural network model are also lost, the at least one processor 2100 may identify at least one model list including the linked neural network model from among model lists stored in the at least one memory 2300 and, based on the at least one model list, select a neural network model that generates inferred image data having the highest matching rate with inferred image data generated by the linked neural network model (e.g., a neural network model corresponding to a linked neural network model with the highest priority in the model list) as the at least one recovery neural network model. The at least one processor 2100 may recover the lost neural network model (or the lost sub-neural network model) based on the at least one recovery neural network model.

The display 2200 may output data processing results of the at least one processor 2100 to a user through a display panel.

The at least one memory 2300 may include a VM such as a static random access memory (SRAM), a dynamic RAM (DRAM), a synchronous RAM (SDRAM), etc. and/or an NVM such as a phase-change RAM (PRAM), a magneto-resistive RAM (MRAM), an ReRAM, an FRAM, etc.

The at least one memory 2300 according to one or more embodiments may include a plurality of storage devices, and each of the plurality of storage devices may be implemented like the computational storage system 200 as described above with reference to FIGS. 1 to 8. Also, the at least one memory 2300, the at least one processor 2100, the display 2200, the modem 2400, the input/output device 2500, and the power supply 2600 may be connected to one another through a channel 2700, and the channel 2700 may be used for data exchange between the at least one memory 2300, the at least one processor 2100, the display 2200, the modem 2400, the input/output device 2500, and the power supply 2600.

The modem 2400 may support at least one of various wireless/wired communication protocols to communicate with a device or a system outside the electronic device 2000. The input/output device 2500 may mediate communication between a user and the electronic device 2000 through a user interface including various input/output interfaces. The power supply 2600 may perform power supply and overall power-related management of the electronic device 2000.

By using the electronic device 2000 according to the disclosure as described above, the at least one processor 2100 generates a region-specific (and/or section-specific) neural network model, generates region-specific (and/or section-specific) inferred image data by using the region-specific (and/or section-specific) neural network model, and stores base data, an event table, and a neural network model (e.g., having small data sizes) instead of original image data (e.g., having large data size), thereby maximizing the efficiency of the storage space of the at least one memory 2300.

Also, by using the electronic device 2000 according to the disclosure, even when data in a storage device is lost due to an unexpected event or accident, the at least one processor 2100 may smoothly recover lost data by using a neural network model and at least one sub-neural network model.

At least one of the components, elements, modules or units (collectively “components” in this paragraph) represented by a block in the drawings, may be embodied as various numbers of hardware, software and/or firmware structures that execute respective functions described above, according to an example embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

While the disclosure has been particularly shown and described with reference to example embodiments thereof, it will be understood that various changes in form and details may be made therein without departing from the spirit and scope of the following claims.

What is claimed is:

1. A computational storage system comprising:
a storage device comprising a model storage configured to store a plurality of neural network models; and
a computing device configured to generate inferred image data corresponding to original image data, based on the plurality of neural network models,
wherein the computing device is further configured to, in a process of generating the inferred image data, based on a number of times a target neural network model from among the plurality of neural network models is used increasing by a first threshold value or more, generate at least one first sub-neural network model by dividing the target neural network model and store the at least one first sub-neural network model in the model storage.

2. The computational storage system of claim 1, wherein the computing device is further configured to, for each of the at least one first sub-neural network model:
compare matching rates between inferred image data generated by a first sub-neural network model and inferred image data generated by each of the plurality of neural network models and at least one remaining sub-neural network model of the at least one first sub-neural network model stored in the model storage,
based on results of the comparison, generate a model list by listing up the plurality of neural network models and the at least one remaining sub-neural network model in a descending order of matching rates, and
map the first sub-neural network model and the model list and store information about the mapping in the model storage.

3. The computational storage system of claim 1, wherein the computing device is further configured to, in the process of generating the inferred image data, based on a number of times a target sub-neural network model from among the at least one first sub-neural network model is used increasing by the first threshold value or more, divide the target sub-neural network model to generate at least one second sub-neural network model and store the at least one second sub-neural network model in the model storage.

4. The computational storage system of claim 3, wherein the computing device is further configured to, based on a presence of a first replacement neural network model that is configured to generate inferred image data having a matching rate greater than or equal to a second threshold value with respect to inferred image data generated by the at least one second sub-neural network model:
delete the at least one second sub-neural network model; and
link the first replacement neural network model to the target sub-neural network model.

5. The computational storage system of claim 1, wherein the computing device is further configured to generate at least one sub-neural network model by dividing the target neural network model until a total data size, obtained by summing data sizes of the plurality of neural network models and data sizes of the at least one sub-neural network model, reaches a data size allocated to the model storage.

6. The computational storage system of claim 3, wherein the computing device is further configured to, based on re-division of the target neural network model being needed, delete at least one sub-neural network model, among the at least one first sub-neural network model and the at least one second sub-neural network model, of which a number of times of use is less than a third threshold value, and re-divide the target neural network model.

7. The computational storage system of claim 3, wherein the computing device is further configured to, based on a number of times of use of at least one sub-neural network model, among the at least one first sub-neural network model and the at least one second sub-neural network model, decreasing below a third threshold value due to an increase in a number of times of use of a second replacement neural network model:
delete the at least one sub-neural network model; and
link the target neural network model to the second replacement neural network model.

8. The computational storage system of claim 1, wherein each of the plurality of neural network models includes at least one of a neural network model corresponding to at least one region included in the original image data and a neural network model corresponding to at least one section included in the original image data.

9. The computational storage system of claim 1, wherein each of the plurality of neural network models is configured to generate the inferred image data corresponding to the original image data, based on base data and an event table,
wherein the base data includes base raw data of at least one object included in the original image data, and
wherein the event table includes data obtained by mapping at least one event occurring in the base data to an occurrence time of the at least one event.

10. A computational storage system comprising:
a storage device comprising a model storage, the model storage being configured to store a plurality of neural network models, at least one sub-neural network model generated by dividing at least one of the plurality of neural network models, and model lists respectively corresponding to the at least one sub-neural network model; and
a computing device configured to generate inferred image data corresponding to original image data, based on the plurality of neural network models and the at least one sub-neural network model,
wherein the computing device is further configured to, based on at least one of the plurality of neural network models and the at least one sub-neural network model being lost:
based on a model list of the lost at least one neural or sub-neural network model, select at least one recovery neural network model from among the plurality of neural network models and the at least one sub-neural network model; and
recover the lost at least one neural or sub-neural network model by using the at least one recovery neural network model.

11. The computational storage system of claim 10, wherein the computing device is further configured to, based on the model list of the lost at least one neural or sub-neural network model being lost, select a linked neural network model linked to the lost at least one neural or sub-neural network model as the at least one recovery neural network model.

12. The computational storage system of claim 10, wherein the computing device is further configured to, based on the model list of the lost at least one neural or sub-neural network model being lost and a linked neural network model linked to the lost at least one neural or sub-neural network model being also lost, select the at least one recovery neural network model from among the plurality of neural network models and the at least one sub-neural network model, based on a model list of the linked neural network model.

13. The computational storage system of claim 12, wherein the computing device is further configured to, based on the model list of the lost at least one neural or sub-neural network model being lost and the linked neural network model and the model list of the linked neural network model being also lost:
identify at least one model list comprising the linked neural network model from among the model lists stored in the model storage; and
select, based on the at least one model list, a neural network model configured to generate inferred image data having a highest matching rate with inferred image data generated by the linked neural network model, as the at least one recovery neural network model.

14. The computational storage system of claim 10, wherein each of the plurality of neural network models includes at least one of a neural network model corresponding to at least one region included in the original image data and a neural network model corresponding to at least one section included in the original image data.

15. The computational storage system of claim 10, wherein each of the plurality of neural network models is configured to generate the inferred image data corresponding to the original image data, based on base data and an event table,
wherein the base data includes to base raw data of at least one object included in the original image data, and
wherein the event table includes data obtained by mapping at least one event occurring in the base data to an occurrence time of the at least one event.

16. An electronic device comprising:
at least one memory configured to store a plurality of neural network models; and
at least one processor configured to:
generate inferred image data corresponding to original image data, based on base data and an event table generated from the original image data, by using the plurality of neural network models; and,
based on a number of times a target neural network model from among the plurality of neural network models is used increasing by a threshold value or more during a process of generating the inferred image data, divide the target neural network model to generate at least one sub-neural network model.

17. The electronic device of claim 16, wherein the at least one processor is further configured to, for each of the at least one sub-neural network model:
obtain matching rates between inferred image data generated by a sub-neural network model and inferred image data generated by each of the plurality of neural network models and at least one remaining sub-neural network model of the at least one sub-neural network model; and
store a model list generated by listing up the plurality of neural network models and the at least one remaining sub-neural network model in a descending order of matching rates in the at least one memory.

18. The electronic device of claim 17, the at least one processor is further configured to, based on at least one of the plurality of neural network models and the at least one sub-neural network model being lost:
based on a model list of the lost at least one neural or sub-neural network model, select at least one recovery neural network model from among the plurality of neural network models and the at least one sub-neural network model; and
recover the lost at least one neural or sub-neural network model by using the at least one recovery neural network model.

19. The electronic device of claim 18, wherein the at least one processor is further configured to, in selecting the at least one recovery neural network model:
select, based on the model list of the lost at least one neural or sub-neural network model being lost, a linked neural network model linked to the lost at least one neural or sub-neural network model as the at least one recovery neural network model.

20. The electronic device of claim 18, wherein the at least one processor is further configured to, in selecting the at least one recovery neural network model:
based on the model list of the lost at least one neural or sub-neural network model being lost, and a linked neural network model linked to the lost at least one neural or sub-neural network model and a model list of the linked neural network model being also lost, identify at least one model list comprising the linked neural network model from among model lists stored in the at least one memory; and
select, based on the identified at least one model list, a neural network model, which is configured to generate inferred image data having a highest matching rate with inferred image data generated by the linked neural network model, as the at least one recovery neural network model.
